(19) United States
(12) Patent Application Publication
(10) Pub. No.: US 2026/0170365 A1
(43) Pub. Date: Jun. 18, 2026

(54) SEARCH DEVICE, SEARCH METHOD, AND PROGRAM

(71) Applicant: Panasonic Intellectual Property Management Co., Ltd., Osaka (JP)

(72) Inventors: TAICHI NAKAMURA, Osaka (JP); RYO MIYA, Osaka (JP); HIROAKI YOSHIDA, Osaka (JP)

(21) Appl. No.: 19/534,847

(22) Filed: Feb. 10, 2026

Related U.S. Application Data
(63) Continuation of application No. PCT/JP2024/022064, filed on Jun. 18, 2024.

(30) Foreign Application Priority Data
Sep. 11, 2023 (JP) 2023-147173

(51) Int. Cl. G06N 5/04; G06N 5/01

(52) U.S. Cl. CPC G06N 5/04; G06N 5/01

(57) ABSTRACT

Search device (100) includes first data set update unit (111) that updates first data set (121) indicating target variable y and a first explanatory variable in association with each other, first prediction model generation unit (130) that generates first prediction model (123) by using first data set (121), search condition derivation unit (160) that derives a search condition for obtaining a target value of target variable y by using first prediction model (123), and prediction unit (150) that predicts whether or not a characteristic value indicated by target variable y deviates from a target value when the processing on a raw material according to the search condition is continuously performed, in which first data set update unit (111) adds a second explanatory variable to first data set (121) in a case where the characteristic value deviates from the target value, and first prediction model generation unit (130) updates first prediction model (123) by using first data set (121) to which the second explanatory variable is added.

### TECHNICAL FIELD

The present disclosure relates to a search device that searches for a condition used for processing of a raw material, and the like.

### BACKGROUND ART

A material processing apparatus such as a chemical reactor and a semiconductor processing apparatus generates a product by performing processing such as synthesis and processing of a raw material according to a processing condition. A characteristic value of the product varies depending on various processing conditions of the material processing apparatus. For example, a characteristic value of a product is obtained for each of a plurality of mutually different processing conditions. Here, in order to obtain a product having a target characteristic value, it is necessary to search for an input parameter from which an output parameter indicating the target characteristic value is obtained from a plurality of input parameters indicating mutually different values as processing conditions. However, it is not realistic to actually measure or evaluate an output parameter for each of all input parameters. For this reason, a search for an optimal solution of an input parameter is performed using a method based on machine learning such as a neural network.

PTL 1 discloses a search device that generates a prediction model indicating a relationship between an input parameter and an output parameter by machine learning and searches for an optimal solution based on the prediction model. Specifically, the search device of PTL 1 obtains, as a predicted value, a value of an input parameter from which an output parameter indicating a target characteristic value is obtained based on a prediction model, and determines whether or not an actually measured value corresponding to the predicted value reaches a target. Note that the actually measured value is an actually measured characteristic value of a product obtained by processing according to a predicted value by a semiconductor processing apparatus. Then, when the actually measured value does not reach the target, the search device updates the prediction model by adding the predicted value and the actually measured value to training data as a new input parameter and a new output parameter. As a result, search efficiency is improved. Furthermore, when the actually measured value is not close to the target, the search device of PTL 1 excludes a region where a combination of the actually measured value and the predicted value exists from a search region. By the above, accuracy of reaching an optimum solution is improved.

### CITATION LIST

### Patent Literature

PTL 1: Unexamined Japanese Patent Publication No. 2019-40984

### SUMMARY OF THE INVENTION

A search device according to a first aspect of the present disclosure includes a first data set update unit that generates or updates a first data set indicating a target variable and a first explanatory variable in association with each other, the target variable indicating a characteristic value of a product obtained by processing by a material processing apparatus, the processing being performed on a raw material according to the first explanatory variable, a first prediction model generation unit that generates a first prediction model by using the first data set, the first prediction model indicating a relationship between the first explanatory variable and the target variable, a search condition derivation unit that derives, as a search condition, a value of the first explanatory variable for obtaining a target value of the target variable, the deriving being performed by a search using the first prediction model, and a prediction unit that predicts whether or not the characteristic value indicated by the target variable deviates from the target value at a time point later than a current time point when the processing on the raw material according to the search condition derived by the search condition derivation unit is continuously performed. The first data set update unit updates the first data set in a case where the prediction unit predicts that the characteristic value deviates from the target value by adding a second explanatory variable to the first data set, the second explanatory variable indicating a state of the raw material, and the first prediction model generation unit updates the first prediction model by using the first data set updated by addition of the second explanatory variable.

Note that these comprehensive or specific aspects may be implemented by a system, a method, an integrated circuit, a computer program, or a recording medium such as a computer-readable CD-ROM, or may be implemented by any combination of the system, the method, the integrated circuit, the computer program, and the recording medium. Further, the recording medium may be a non-transitory recording medium.

Note that further advantages and effects of one aspect of the present disclosure will become clear from the description and drawings. Such advantages and/or effects are provided by the configuration described in some exemplary embodiments and the description and drawings, but not necessarily all configurations are required.

### BRIEF DESCRIPTION OF THE DRAWINGS

FIG. 1 is a diagram illustrating an example of a processing system according to a first exemplary embodiment.

FIG. 2 is a block diagram illustrating an example of a configuration of a material processing apparatus according to the first exemplary embodiment.

FIG. 3 is a block diagram illustrating an example of a configuration of a search device according to the first exemplary embodiment.

FIG. 4 is a diagram illustrating an example of a first data set and a second data set according to the first exemplary embodiment.

FIG. 5 is a diagram illustrating an example of the first data set updated by adding a second explanatory variable in the first exemplary embodiment.

FIG. 6 is a flowchart illustrating an example of processing operation of the search device according to the first exemplary embodiment.

FIG. 7 is a block diagram illustrating an example of a configuration of the material processing apparatus according to a second exemplary embodiment.

FIG. 8 is a block diagram illustrating an example of a configuration of the search device according to the second exemplary embodiment.

FIG. 9 is a diagram illustrating an example of the first data set updated by adding the second explanatory variable and a third explanatory variable in the second exemplary embodiment.

FIG. 10 is a flowchart illustrating an example of processing operation of the search device according to the second exemplary embodiment.

### DESCRIPTION OF EMBODIMENT

### Knowledge Underlying Present Invention

The inventor of the present invention has found that there is a problem that accuracy of searching may be reduced as follows in PTL 1 described in the section of “BACKGROUND ART”.

The search device of PTL 1 searches for an optimal solution without considering a temporal change of a raw material. Therefore, in the search device of PTL 1, in a case where a raw material having a large temporal change is used for producing a product, accuracy of searching for an optimal solution is reduced as time elapses.

That is, even if a processing condition (that is, an input parameter) that is considered as an optimal solution is searched for by the search device of PTL 1, in a case where the material processing apparatus continuously executes production of a product under the processing condition by using a raw material having a large temporal change, a characteristic value of a product generated at a certain time point may greatly deviate from a target as time elapses. In other words, in a continuous process in which production of a product is continuously executed, in a case where a raw material having a large temporal change is used, accuracy of searching for an optimal solution is reduced.

As a material processing apparatus that performs a continuous process, an apparatus, also called a microreactor, having a flow path forming body is known. In this microreactor, liquids (that is, reactants) soluble in each other are brought into contact with each other and mixed so that the liquids react together to produce a desired product. In such a microreactor, since a product is produced in a microscale reaction field, a high-quality product with little variation is easily obtained. On the other hand, in a microreactor, in a case where a large amount of product is produced, time during which a raw material is used for producing the product becomes long. As a result, in a case where a physical property value of a raw material greatly changes as time elapses, that is, in a case where a temporal change of the raw material is large, a characteristic value of a product to be produced may also greatly change as time elapses. Therefore, even if a continuous process is started under a processing condition that is considered as an optimal solution, it is not possible to produce a large amount of product having a target characteristic value.

The present disclosure provides a search device capable of improving accuracy of searching.

A search device according to a first aspect of the present disclosure includes a first data set update unit that generates or updates a first data set indicating a target variable and a first explanatory variable in association with each other, the target variable indicating a characteristic value of a product obtained by processing by a material processing apparatus, the processing being performed on a raw material according to the first explanatory variable, a first prediction model generation unit that generates a first prediction model by using the first data set, the first prediction model indicating a relationship between the first explanatory variable and the target variable, a search condition derivation unit that derives, as a search condition, a value of the first explanatory variable for obtaining a target value of the target variable, the deriving being performed by a search using the first prediction model, and a prediction unit that predicts whether or not the characteristic value indicated by the target variable deviates from the target value at a time point later than a current time point when the processing on the raw material according to the search condition derived by the search condition derivation unit is continuously performed. The first data set update unit updates the first data set in a case where the prediction unit predicts that the characteristic value deviates from the target value by adding a second explanatory variable to the first data set, the second explanatory variable indicating a state of the raw material, and the first prediction model generation unit updates the first prediction model by using the first data set updated by addition of the second explanatory variable. Note that the first explanatory variable and the search condition are also referred to as processing conditions.

The search device of the present disclosure can improve accuracy of searching. Specifically, when a search condition is derived as an optimal solution, and processing on a raw material according to the search condition is continuously performed, that is, at the continuous process stage, it is predicted whether or not a characteristic value of a raw material deviates from a target value at a time point later than a current time point. Therefore, in a case where there is a temporal change in a raw material, it is predicted that a characteristic value deviates from a target value. In such a case, the first prediction model is updated by using the first data set to which the second explanatory variable indicating a state of a raw material is added. As a result, if a search using the updated first prediction model is performed again, a search in consideration of the second explanatory variable, that is, a search in consideration of a temporal change of a raw material can be performed. Therefore, if processing on a raw material according to a new search condition derived by the search is performed continuously, the possibility of maintaining a characteristic value at a target value can be increased even at a time point later than the above-described current time point. By the above, accuracy of searching for an optimal solution can be improved even in a case where a raw material having a large temporal change is used for producing a product, and a large amount of product having a target characteristic value can be produced continuously. Note that the optimal solution is a search condition, a processing condition, or a value of the first explanatory variable for generating a product having a characteristic value as a target value.

Further, the search device according to a second aspect may further include a second data set update unit that acquires the second explanatory variable and the target variable and generates or updates a second data set indicating the acquired second explanatory variable and the acquired target variable in association with each other when processing on the raw material according to the search condition derived by the search condition derivation unit is continuously performed, and a second prediction model generation unit that generates a second prediction model by using the second data set, the second prediction model indicating a temporal relationship between the second explanatory variable and the target variable, in which the prediction unit may predict whether or not the characteristic value deviates from the target value by using the second prediction model. For example, the second data set indicates the actually measured second explanatory variable and target variable in association with each other. Note that the second aspect may be dependent on the first aspect.

By the above, it is possible to predict with high accuracy whether or not a characteristic value deviates from a target value at a time point later than a current time point.

Further, in the search device according to a third aspect, the first data set update unit, in the adding the second explanatory variable to the first data set, may update the first data set to a data set indicating the first explanatory variable, the second explanatory variable, and the target variable in association with each other by integrating the second data set into the first data set. Note that the third aspect may be dependent on the second aspect.

By the above, the first explanatory variable and the second explanatory variable and the target variable can be appropriately associated with each other, and the second explanatory variable can be effectively added to the first data set.

Further, in the search device according to a fourth aspect, in a case where the prediction unit predicts that the characteristic value deviates from the target value when the state of the raw material indicated by the second explanatory variable is a predetermined state, the search condition derivation unit may derive, as a new search condition, a value of the first explanatory variable for obtaining the target value of the target variable when the state of the raw material is the predetermined state, the deriving being performed by a search using the updated first prediction model. Note that the fourth aspect may be dependent on the second aspect or the third aspect.

By the above, even if a raw material is brought into the predetermined state by a temporal change, it is possible to produce a product having a target characteristic value by causing the material processing apparatus to execute processing according to the new search condition.

Further, in the search device according to a fifth aspect, the first data set update unit may update the first data set by adding a third explanatory variable for adjusting a state of the raw material to the first data set together with the second explanatory variable when adding the second explanatory variable to the first data set, and the first prediction model generation unit may update the first prediction model by using the first data set updated by addition of the second explanatory variable and the third explanatory variable. Note that the fifth aspect may be dependent on any one of the second to fourth aspects.

For example, in the material processing apparatus, a state of a raw material is adjusted according to the third explanatory variable. By the above, by performing a search using the first prediction model, it is possible to perform a search in consideration of a state of a raw material that changes over time and adjustment to the state. As a result, it is possible to derive an optimal solution of a search condition for producing a product having a characteristic value as a target value with high accuracy, the search condition including a value of the first explanatory variable and a value of the third explanatory variable.

Hereinafter, an exemplary embodiment will be specifically described with reference to the drawings.

Note that the exemplary embodiment described below illustrates a comprehensive or specific example. Numerical values, shapes, materials, components, disposition positions and connection modes of the components, steps, order of the steps, and the like illustrated in the following exemplary embodiment are merely examples, and therefore are not intended to limit the present disclosure. Further, among components according to the following exemplary embodiment, those not recited in an independent claim representing the most superordinate concept will be described as optional components. Further, each of the drawings is a schematic diagram, and is not necessarily strictly illustrated. Further, in the drawings, identical reference marks are given to the same constituent members.

### First Exemplary Embodiment

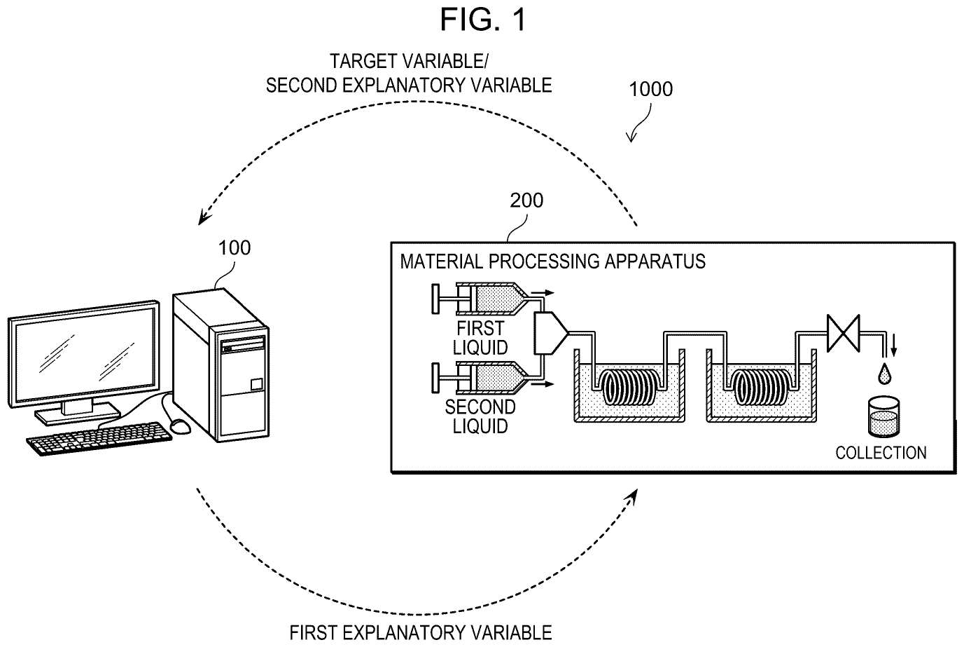

FIG. 1 is a diagram illustrating an example of a processing system according to the present exemplary embodiment.

Processing system 1000 according to the present exemplary embodiment can improve accuracy of searching for an optimal solution even in a case where a raw material having a large temporal change is used for producing a product, and can continuously produce a large amount of product having a target characteristic value. Further, a processing stage of processing system 1000 is switched between a search stage and a continuous process stage. The search stage is a stage of searching for a processing condition (that is, a search condition) for processing a raw material, and the continuous process stage is a stage of continuously processing a raw material according to the search condition, that is, a stage at which a continuous process is performed. Such processing system 1000 includes search device 100 and material processing apparatus 200.

Material processing apparatus 200 is an apparatus that generates a product by processing a raw material. For example, material processing apparatus 200 performs flow synthesis by causing a plurality of types of liquid (for example, first liquid and second liquid) as raw materials to flow through a flow path and causing the liquid to sequentially react with each other in the flow path. Further, liquid flowing in the flow path may be heated or cooled. A product is generated by such flow synthesis. Note that material processing apparatus 200 according to the present exemplary embodiment may be referred to as a reactor or a chemical reactor. Further, material processing apparatus 200 according to the present exemplary embodiment is not limited to the example illustrated in FIG. 1, and may be an apparatus having another configuration such as a semiconductor processing apparatus as long as material processing apparatus 200 is an apparatus that performs processing on a raw material as a continuous process.

At the search stage, search device 100 searches for a processing condition of material processing apparatus 200 for obtaining a target characteristic value (also referred to as physical property value) of a product. That is, search device 100 searches for an optimal solution of a processing condition. Note that a processing condition is expressed as a first explanatory variable or an input parameter, and a characteristic value of a product is expressed as a target variable or an output parameter. Such search device 100 inputs or sets a first explanatory variable to material processing apparatus 200, and acquires, from material processing apparatus 200, a target variable obtained by processing a raw material according to the first explanatory variable. Then, search device 100 generates a first prediction model by using the known first explanatory variable and a target variable, and derives, as an optimal solution, a processing condition for obtaining a target characteristic value, that is, a value of the first explanatory variable, by using the first prediction model. Note that the value of the first explanatory variable and the processing condition are also referred to as search conditions. Then, at the continuous process stage, search device 100 sets, in material processing apparatus 200, a value of the first explanatory variable (that is, a processing condition) derived as an optimal solution, and causes material processing apparatus 200 to execute processing on a raw material according to a value of the first explanatory variable as a continuous process.

Further, at the continuous process stage in which material processing apparatus 200 executes a continuous process, search device 100 continuously acquires a target variable obtained by processing a raw material according to a value of the first explanatory variable and a second explanatory variable indicating a state of the raw material from material processing apparatus 200. Then, by using the known second explanatory variable and target variable, search device 100 predicts whether or not a characteristic value of a product indicated by the target variable deviates from the target value at a time point later than a current time point. When it is predicted by search device 100 that the characteristic value of the product deviates from the target value, the continuous process stage is stopped, and the processing stage of processing system 1000 transitions from the continuous process stage to the search stage. Then, in the search stage, search device 100 executes a search for a processing condition by using the second explanatory variable.

Note that in a specific example, search device 100 is configured as a personal computer or a server, and is connected to an input device such as a keyboard and a mouse and a display device such as a display.

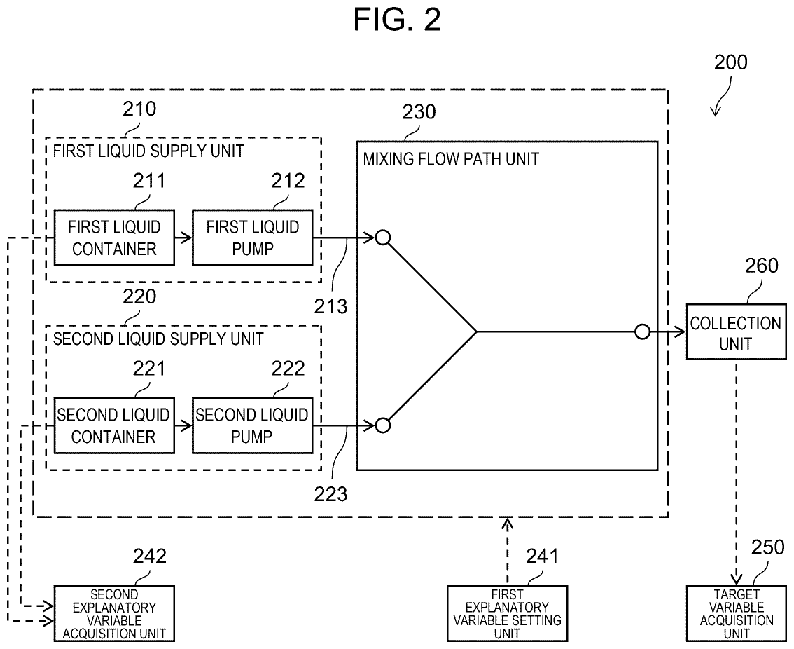

FIG. 2 is a block diagram illustrating an example of a configuration of material processing apparatus 200 according to the present exemplary embodiment.

Material processing apparatus 200 according to the present exemplary embodiment is a reactor that generates mixed liquid as a product by mixing and synthesizing first liquid and second liquid soluble in each other. Such material processing apparatus 200 includes first liquid supply unit 210, second liquid supply unit 220, mixing flow path unit 230, first explanatory variable setting unit 241, second explanatory variable acquisition unit 242, target variable acquisition unit 250, and collection unit 260. Note that, in FIG. 2, flow of liquid is indicated by a solid arrow.

First liquid supply unit 210 supplies the first liquid to mixing flow path unit 230 via first liquid flow path 213. Specifically, first liquid supply unit 210 includes first liquid container 211 and first liquid pump 212. First liquid container 211 is a container that contains the first liquid. First liquid pump 212 pumps out the first liquid in first liquid container 211 and delivers the first liquid to mixing flow path unit 230 via first liquid flow path 213 under pressure.

Second liquid supply unit 220 supplies the second liquid to mixing flow path unit 230 via second liquid flow path 223. Specifically, second liquid supply unit 220 includes second liquid container 221 and second liquid pump 222. Second liquid container 221 is a container that contains the second liquid. Second liquid pump 222 pumps out the second liquid in second liquid container 221 and delivers the second liquid to mixing flow path unit 230 via second liquid flow path 223 under pressure.

Mixing flow path unit 230 has a mixing flow path for sequentially mixing the first liquid flowing through first liquid flow path 213 and the second liquid flowing through second liquid flow path 223, and allowing the liquid to flow. The first liquid and the second liquid are mixed, so that mixed liquid is generated and flows through the mixing flow path. Note that the mixed liquid is also referred to as a synthetic material, a produced material, or a product. Mixing flow path unit 230 as described above may have a flow path including, for example, a microreactor and a micromixer. In this case, a diameter of the flow path is several micrometers to several millimeters, and it can be said that material processing apparatus 200 is a microflow reactor that performs microflow synthesis.

First explanatory variable setting unit 241 sets a value of the first explanatory variable derived by search device 100 on at least one of first liquid supply unit 210, second liquid supply unit 220, first liquid flow path 213, second liquid flow path 223, and mixing flow path unit 230. By the above, material processing apparatus 200 performs mixing of the first liquid and the second liquid according to the first explanatory variable as processing on a raw material. The first explanatory variable indicates, for example, heating temperature, concentration of a raw material, a flow rate of a raw material, and the like. Note that the first explanatory variable is not limited to these, and may indicate other numerical values. The heating temperature is, for example, at least one of a set temperature for first liquid supply unit 210 to heat the first liquid and a set temperature for second liquid supply unit 220 to heat the second liquid. In this case, first liquid supply unit 210 and second liquid supply unit 220 may include a thermostatic bath or the like that allows control of temperature of the first liquid and the second liquid according to the first explanatory variable. Alternatively, the heating temperature is, for example, a set temperature for heating mixed liquid. In this case, mixing flow path unit 230 may include a thermostatic bath or the like that allows control of temperature of mixed liquid according to the first explanatory variable. Further, the concentration of a raw material is, for example, concentration of at least one of the first liquid and the second liquid. In this case, first liquid supply unit 210 and second liquid supply unit 220 may have a mechanism capable of adjusting the concentration according to the first explanatory variable. Further, the flow rate of a raw material is, for example, a flow rate of at least one of the first liquid and the second liquid. In this case, first liquid supply unit 210 and second liquid supply unit 220 may adjust a flow rate of supplied liquid according to the first explanatory variable. Further, a mixing ratio of the first liquid and the second liquid may be adjusted by adjustment of concentration or a flow rate of a raw material.

Second explanatory variable acquisition unit 242 includes a sensor, and acquires the second explanatory variable indicating a state of a raw material by using the sensor. Specifically, second explanatory variable acquisition unit 242 measures and acquires molecular weight, pH, viscosity, temperature, and the like of each of the first liquid and the second liquid contained in first liquid container 211 and second liquid container 221 as the second explanatory variables. Note that the second explanatory variable is not limited to these, and may indicate other numerical values.

Target variable acquisition unit 250 includes a sensor, and acquires a target variable indicating a characteristic value of a product that is mixed liquid by using the sensor. For example, the characteristic value is particle size, particle size distribution, absorbance, or the like of a product, but is not limited to these, and may be other numerical values. Further, an acquired target variable indicates a value actually measured by the above-described sensor.

Collection unit 260 collects a product that is mixed liquid.

Note that although material processing apparatus 200 illustrated in FIG. 2 mixes two types of liquid, the number of types of liquid to be mixed is not limited to two, and may be three or more. For example, in a case where the number of types is three or more, material processing apparatus 200 includes liquid supply units as many as the number of types. These liquid supply units have the same configuration as first liquid supply unit 210 and second liquid supply unit 220, and supply a type of liquid corresponding to the liquid supply units to mixing flow path unit 230.

Further, a main component of the first liquid and the second liquid according to the present exemplary embodiment is water, but the first liquid and the second liquid only need to be any liquid as long as they are soluble in each other, and may be either water-soluble or water-insoluble. For example, the first liquid and the second liquid may be water or an aqueous solution, or may be an organic solvent or oil-based liquid.

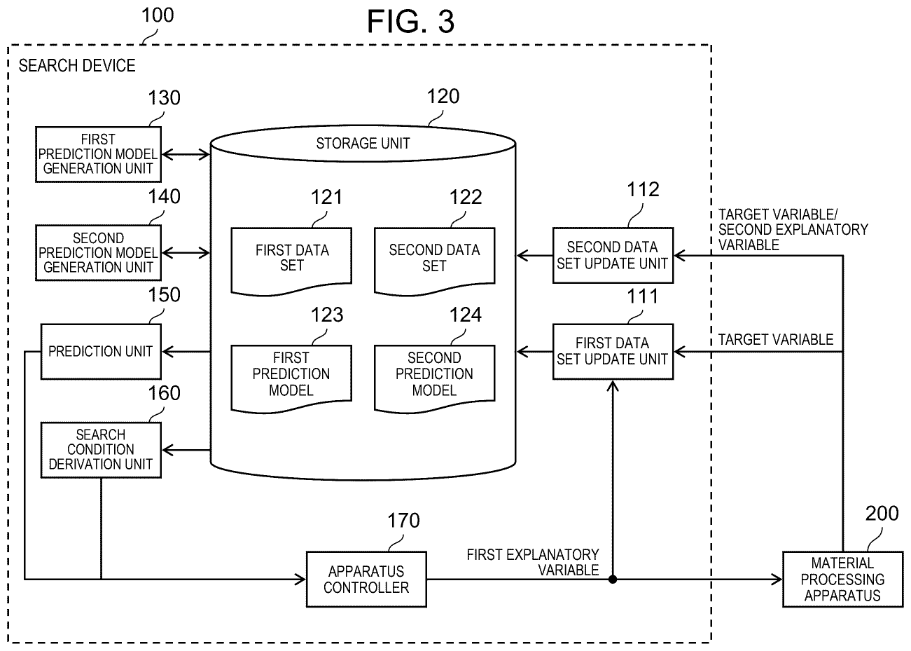

FIG. 3 is a block diagram illustrating an example of a configuration of search device 100 according to the present exemplary embodiment.

Search device 100 includes first data set update unit 111, second data set update unit 112, storage unit 120, first prediction model generation unit 130, second prediction model generation unit 140, prediction unit 150, search condition derivation unit 160, and apparatus controller 170.

In the search stage, first data set update unit 111 acquires the first explanatory variable from apparatus controller 170, and acquires a target variable obtained by mixing according to the first explanatory variable from target variable acquisition unit 250 of material processing apparatus 200. That is, first data set update unit 111 acquires a combination including a value indicated by the first explanatory variable and a value indicated by a target variable. The value indicated by the first explanatory variable is also referred to as a value of the first explanatory variable, and the value indicated by a target variable is also referred to as a value of a target variable. Then, first data set update unit 111 generates or updates first data set 121 including the combination. That is, if first data set 121 is not stored in storage unit 120, first data set update unit 111 generates first data set 121 including the combination and stores first data set 121 in storage unit 120. On the other hand, if first data set 121 is already stored in storage unit 120, data set update unit 110 updates first data set 121 stored in storage unit 120 by reading existing first data set 121 from storage unit 120 and including an acquired combination in existing first data set 121. Such first data set 121 indicates the first explanatory variable and a target variable in association with each other by including one or more of the above-described combinations.

As described above, first data set update unit 111 according to the present exemplary embodiment generates or updates first data set 121 indicating a target variable indicating a characteristic value of a product obtained by processing on a raw material according to the first explanatory variable by material processing apparatus 200 and the first explanatory variable in association with each other.

Storage unit 120 is a recording medium for storing first data set 121 and the like. Storage unit 120 according to the present exemplary embodiment has storage capacity for storing not only first data set 121 but also second data set 122, first prediction model 123, and second prediction model 124. For example, storage unit 120 is a hard disk drive, a Random Access Memory (RAM), a Read Only Memory (ROM), a semiconductor memory, or the like. Note that storage unit 120 may be volatile or non-volatile.

At the search stage, first prediction model generation unit 130 reads first data set 121 from storage unit 120, and uses first data set 121 to generate first prediction model 123 indicating a relationship between the first explanatory variable and a target variable. First prediction model 123 is, for example, a model generated by machine learning so as to output, with respect to input of a value of a target variable, a value of the first explanatory variable for obtaining the value. That is, first prediction model generation unit 130 generates first prediction model 123 by machine learning using first data set 121. First prediction model 123 is, for example, a neural network. First prediction model generation unit 130 stores generated first prediction model 123 in storage unit 120.

At the search stage, search condition derivation unit 160 reads first prediction model 123 from storage unit 120 and performs a search using first prediction model 123 to derive, as a search condition, a value of the first explanatory variable for obtaining a target value of a target variable. Then, search condition derivation unit 160 outputs the value of the first explanatory variable, which is a derived search condition, to apparatus controller 170. Note that the search condition is used as a condition of processing by material processing apparatus 200, that is, the above-described processing condition.

Apparatus controller 170 controls material processing apparatus 200. Specifically, when acquiring a value of the first explanatory variable as a processing condition from search condition derivation unit 160, apparatus controller 170 outputs the value of the first explanatory variable to material processing apparatus 200 and causes material processing apparatus 200 to perform mixing according to the value of the first explanatory variable. Note that the value of the first explanatory variable that is a processing condition is also output from apparatus controller 170 to first data set update unit 111.

By the above, material processing apparatus 200 outputs a new value of a target variable obtained according to the derived value of the first explanatory variable to first data set update unit 111. Specifically, first explanatory variable setting unit 241 of material processing apparatus 200 sets the value of the first explanatory variable. Then, target variable acquisition unit 250 of material processing apparatus 200 outputs a new value of a target variable obtained by processing according to the value of the first explanatory variable to first data set update unit 111.

First data set update unit 111 updates first data set 121 using the new value of the target variable in the same manner as described above. Here, in a case where the new value of the target variable reaches a target value, the search for a search condition is stopped. That is, as a result of a search, a value of an explanatory variable derived immediately before is determined as an optimal solution. By the above, the search stage is stopped, and the processing stage of processing system 1000 transitions from the search stage to the continuous process stage. For example, apparatus controller 170 causes material processing apparatus 200 to start the continuous process.

In the continuous process stage, second data set update unit 112 continuously acquires the second explanatory variable and a target variable from second explanatory variable acquisition unit 242 and target variable acquisition unit 250 of material processing apparatus 200. That is, second data set update unit 112 acquires a combination including a value indicated by the second explanatory variable and a value indicated by a target variable. A value indicated by the second explanatory variable is also referred to as a value of the second explanatory variable. Second data set update unit 112 may periodically acquire the combination. Then, second data set update unit 112 generates or updates second data set 122 including the combination. That is, if second data set 122 is not stored in storage unit 120, second data set update unit 112 generates second data set 122 including the combination and stores second data set 122 in storage unit 120. On the other hand, if second data set 122 is already stored in storage unit 120, data set update unit 110 updates second data set 122 stored in storage unit 120 by reading existing second data set 122 from storage unit 120 and including an acquired combination in existing second data set 122. Such second data set 122 indicates the second explanatory variable and a target variable in association with each other by including one or more of the above-described combinations.

As described above, second data set update unit 112 according to the present exemplary embodiment acquires the second explanatory variable and a target variable when processing on a raw material according to a search condition derived by search condition derivation unit 160 is continuously performed, that is, at the time of the continuous process stage, and generates or updates second data set 122 indicating the acquired second explanatory variable and target variable in association with each other.

At the continuous process stage, second prediction model generation unit 140 reads second data set 122 from storage unit 120, and uses second data set 122 to generate second prediction model 124 indicating a temporal relationship between the second explanatory variable and a target variable. Second prediction model 124 is, for example, a model generated by machine learning so as to output, with respect to input at time later than a current time point, values of the second explanatory variable and a target variable at that time. That is, second prediction model generation unit 140 generates second prediction model 124 by machine learning using second data set 122. Second prediction model 124 is, for example, a neural network. Second prediction model generation unit 140 stores generated second prediction model 124 in storage unit 120.

At the continuous process stage, prediction unit 150 reads second prediction model 124 from storage unit 120, and predicts values of the second explanatory variable and a target variable at a time point later than a current time point by using second prediction model 124. Then, prediction unit 150 predicts whether or not a value of a target variable (that is, a characteristic value) at a time point later than a current time point deviates from a target value. That is, prediction unit 150 in the present exemplary embodiment predicts whether or not a characteristic value indicated by a target variable deviates from a target value at a time point later than a current time point when processing on a raw material according to a search condition derived by search condition derivation unit 160 is continuously performed, that is, at the continuous process stage. At this time, prediction unit 150 predicts whether or not the characteristic value deviates from a target value by using second prediction model 124.

When predicting that the characteristic value deviates from the target value, prediction unit 150 causes material processing apparatus 200 to stop the continuous process via apparatus controller 170 and causes first data set update unit 111 to update first data set 121. By the above, a processing stage of processing system 1000 transitions from the continuous process stage to the search stage.

First data set update unit 111 updates first data set 121 by adding the second explanatory variable to first data set 121 according to a prediction result obtained by prediction unit 150. That is, in a case where prediction unit 150 predicts that a characteristic value deviates from a target value, first data set update unit 111 updates first data set 121 by adding the second explanatory variable indicating a state of a raw material to first data set 121. Then, first prediction model generation unit 130 updates first prediction model 123 by using first data set 121 updated by addition of the second explanatory variable.

As a result, first prediction model 123 is updated to a prediction model indicating a relationship between the first and second explanatory variables and a target variable. By the above, search condition derivation unit 160 derives, as a new search condition, a value of the first explanatory variable for obtaining a target value of a target variable by performing a search using updated first prediction model 123 again.

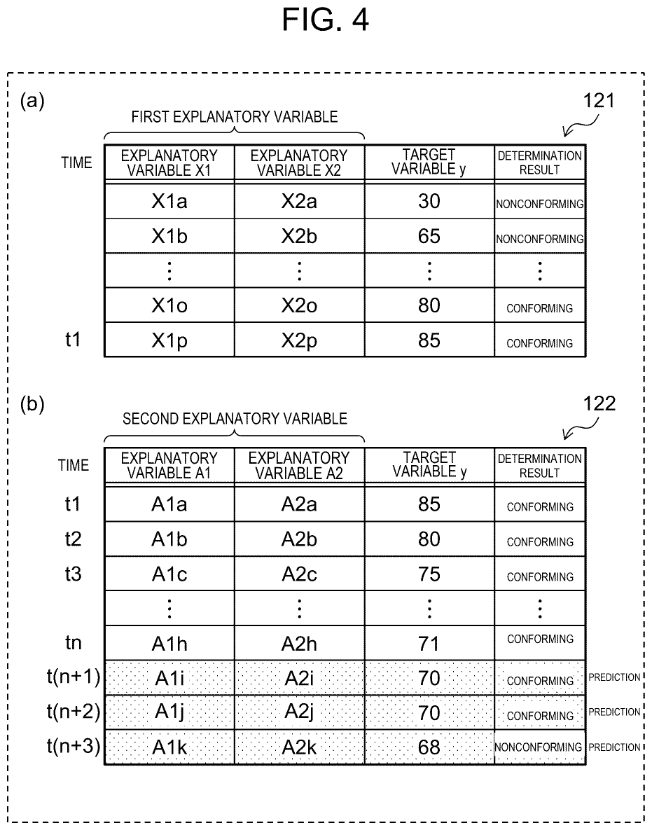

FIG. 4 is a diagram illustrating an example of first data set 121 and second data set 122.

For example, as illustrated in part (a) of FIG. 4, first data set 121 indicates explanatory variable X1, explanatory variable X2, and target variable y in association with each other. Each of explanatory variable X1 and explanatory variable X2 is the first explanatory variable. In a specific example, first data set 121 indicates a value “X1a” of explanatory variable X1, a value “X2a” of explanatory variable X2, and a value “30” of target variable y in association with each other.

For example, search condition derivation unit 160 derives a value “X1b” of explanatory variable X1 and a value “X2b” of explanatory variable X2 as a search condition. In this case, first data set update unit 111 adds the value “X1b” of explanatory variable X1 and the value “X2b” of explanatory variable X2 to first data set 121. Then, material processing apparatus 200 performs processing on a raw material according to the search condition expressed as the value “X1b” of explanatory variable X1 and the value “X2b” of explanatory variable X2, and as a result, a value “65” of target variable y is obtained as an actually measured value. Upon acquiring the value “65” of target variable y from material processing apparatus 200, first data set update unit 111 adds the value “65” of target variable y to first data set 121 in association with the value “X1b” of explanatory variable X1 and the value “X2b” of explanatory variable X2. By the above, a combination including the value “X1b” of explanatory variable X1, the value “X2b” of explanatory variable X2, and the value “65” of target variable y is added to first data set 121.

Further, in a case where a target value is a value more than or equal to a threshold value, first data set update unit 111 compares a value of target variable y with the threshold value, and adds the comparison result as a determination result to first data set 121 in association with the value of target variable y. In the example in part (a) of FIG. 4, a determination result “conforming” indicates that a value of target variable y is more than or equal to a threshold value, and a determination result “nonconforming” indicates that a value of target variable y is less than the threshold value. Further, in the present exemplary embodiment, the threshold value is, for example, 70.

For example, every time the above-described combination is added to first data set 121, first prediction model generation unit 130 generates or updates first prediction model 123 by using all combinations included in first data set 121. Search condition derivation unit 160 derives, as a next search condition, values of explanatory variable X1 and explanatory variable X2 for obtaining a target value of target variable y by using first prediction model 123 generated or updated as described above. That is, search condition derivation unit 160 derives, as a next search condition, values of explanatory variable X1 and explanatory variable X2 with which a value of target variable y reaches a target value. Such derivation of a search condition is repeatedly executed. As a result, for example, a value “80” of target variable y that is more than or equal to a threshold value is obtained with respect to a search condition expressed by a value “X10” of explanatory variable X1 and a value “X20” of explanatory variable X2. A determination result “conforming” is associated with the value “80” of target variable y. Furthermore, a value “85” of target variable y that is more than or equal to a threshold value is obtained with respect to a search condition expressed by a value “X1p” of explanatory variable X1 and a value “X2p” of explanatory variable X2. A determination result “conforming” is also associated with the value “85” of target variable y.

Here, for example, at time t1, search condition derivation unit 160 notifies apparatus controller 170 that a search for a search condition is stopped because the value “85” of target variable y more than or equal to “threshold value+15” is added to first data set 121. In response to the notification, apparatus controller 170 causes material processing apparatus 200 to execute a continuous process according to a search condition associated with the value “85” of target variable y, that is, a continuous process according to the value “X1p” of explanatory variable X1 and the value “X2p” of explanatory variable X2. Note that, in the present exemplary embodiment, when a value of target variable y more than or equal to “threshold value+15” is added to first data set 121, a search is stopped, but the value added to the threshold value is not limited to 15, and may be another numerical value as long as the value is more than or equal to 0.

For example, as illustrated in part (b) of FIG. 4, second data set 122 indicates explanatory variable A1, explanatory variable A2, and target variable y in association with each other. Each of explanatory variable A1 and explanatory variable A2 is the second explanatory variable. In a specific example, second data set 122 indicates a value “A1a” of explanatory variable A1, a value “A2a” of explanatory variable A2, and a value “85” of target variable y in association with each other.

For example, at the continuous process stage, that is, when a continuous process is started by material processing apparatus 200, second data set update unit 112 acquires, from material processing apparatus 200, a combination including each value of explanatory variable A1 and explanatory variable A2 and a value of target variable y. The value of target variable y is a characteristic value of a product obtained by processing performed by material processing apparatus 200 according to the value “X1p” of explanatory variable X1 and the value “X2p” of explanatory variable X2 with respect to a state of a raw material expressed by values of explanatory variable A1 and explanatory variable A2. For example, second data set update unit 112 adds a combination including the value “A1a” of explanatory variable A1, the value “A2a” of explanatory variable A2, and the value “85” of target variable y to second data set 122.

Further, in a case where a target value is a value more than or equal to the above threshold value, second data set update unit 112 compares a value of target variable y with the threshold value, and adds the comparison result as a determination result to second data set 122 in association with the value of target variable y. Note that, in the present exemplary embodiment, the threshold value is, for example, 70. Every time the combination is acquired, second data set update unit 112 adds the combination to second data set 122 together with a determination result.

For example, every time the above-described combination is added to second data set 122, second prediction model generation unit 140 generates or updates second prediction model 124 by using all combinations included in second data set 122. Prediction unit 150 predicts values of explanatory variable A1 and explanatory variable A2 at a time point later than a current time point and a value of a target variable by using second prediction model 124 generated or updated as described above.

For example, in a case where a current time point is time tn, prediction unit 150 predicts values of explanatory variable A1 and explanatory variable A2 and a value of a target variable at each of time t(n+1), t(n+2), and t(t+3), which are time points later than the current time point. Then, prediction unit 150 determines whether or not a value of a target variable predicted at those time points is more than or equal to a threshold value. Prediction unit 150 may add a combination including each of predicted values of explanatory variable A1 and explanatory variable A2 and a value of a target variable and a determination result for the value of the target variable to second data set 122.

Furthermore, when determining that a predicted value of a target variable is less than a threshold value, prediction unit 150 notifies apparatus controller 170 of the determination result. For example, prediction unit 150 notifies apparatus controller 170 that a value “68” of a target variable predicted at time t(t+3) is less than a threshold value “70”. Upon receiving the notification from prediction unit 150, apparatus controller 170 causes material processing apparatus 200 to stop the continuous process. Then, apparatus controller 170 instructs first data set update unit 111 to update first data set 121 using the second explanatory variable.

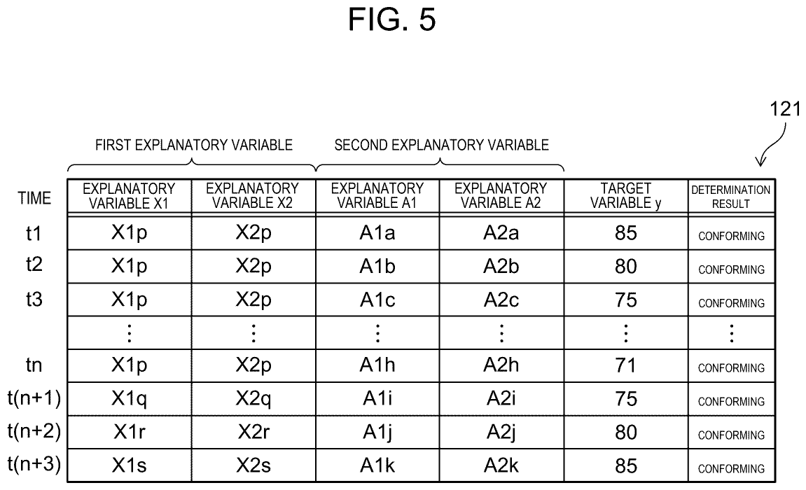

FIG. 5 is a diagram illustrating an example of first data set 121 updated by addition of the second explanatory variable.

For example, as illustrated in FIG. 5, first data set 121 updated by addition of the second explanatory variable indicates explanatory variable X1 and explanatory variable X2 which are the first explanatory variables, explanatory variable A1 and explanatory variable A2 which are the second explanatory variables, and target variable y in association with each other. In the addition of the second explanatory variable to first data set 121, first data set update unit 111 integrates second data set 122 into first data set 121, so as to update first data set 121 to a data set indicating the first explanatory variable, the second explanatory variable, and the target variable in association with each other. First data set 121 updated as described above is hereinafter also referred to as an integrated data set.

In a specific example, the integrated data set indicates a combination at each of times t1 to tn at the continuous process stage and a combination at each of times t(n+1) to t(n+3) at the search stage after the continuous process stage. The combination includes a value of the first explanatory variable, a value of the second explanatory variable, a value of a target variable, and a determination result for a value of the target variable.

When instructed by apparatus controller 170 to update first data set 121 using the second explanatory variable, first data set update unit 111 first adds a combination of each of times t1 to tn to first data set 121. That is, by integrating second data set 122 into first data set 121, the second explanatory variable is added to first data set 121. As a result, first data set 121 is updated to an integrated data set.

First prediction model generation unit 130 generates first prediction model 123 by using the integrated data set that is updated first data set 121. Furthermore, search condition derivation unit 160 derives, as a search condition, a value “X1q” of explanatory variable X1 and a value “X2q” of explanatory variable X2 at time t(n+1) by performing a search using first prediction model 123. First data set update unit 111 acquires, from material processing apparatus 200, a value “75” of target variable y obtained by processing on a raw material according to the search condition, and a value “A1i” of explanatory variable A1 and a value “A2i” of explanatory variable A2 indicating a state of a raw material at that time. Then, first data set update unit 111 determines that the value “75” of target variable y is more than or equal to a threshold value. After the above, first data set update unit 111 adds a combination at the time t(n+1) to first data set 121. The combination includes the value “X1q” of explanatory variable X1 and the value “X2q” of explanatory variable X2, the value “A1i” of explanatory variable A1 and the value “A2i” of explanatory variable A2, the value “75” of target variable y, and the determination result “conforming” for the value “75” of target variable y.

The addition of such a combination to first data set 121 is repeatedly executed, for example, until a value more than or equal to “threshold value+15” is obtained as a value of target variable y. In the present exemplary embodiment, the threshold value is, for example, 70. Here, as illustrated in part (b) of FIG. 4, at time t(n+3), a state of a raw material is changed to a state expressed by a value “A1k” of explanatory variable A1 and a value “A2k” of explanatory variable A2, and as a result, a value of target variable y is predicted to be less than the threshold value. However, in the present exemplary embodiment, even if the state of the raw material changes to the state expressed by the value “A1k” of explanatory variable A1 and the value “A2k” of explanatory variable A2 at the time t(n+3), search condition derivation unit 160 can increase the possibility of deriving a search condition by which a value of target variable y that is more than or equal to the threshold value can be obtained. In the example of FIG. 5, a value “85” of target variable y is obtained at the time t(n+3).

When first data set update unit 111 adds the value “85” of target variable y that is “threshold value+15” or more to first data set 121, search condition derivation unit 160 notifies apparatus controller 170 that the search for a search condition is to be stopped. In response to the notification, apparatus controller 170 causes material processing apparatus 200 to execute a continuous process according to a search condition associated with the value “85” of target variable y, that is, a continuous process according to the value “X1s” of explanatory variable X1 and the value “X2s” of explanatory variable X2. By the above, accuracy of searching can be improved, and a large amount of product having a characteristic value to be a target value can be continuously produced.

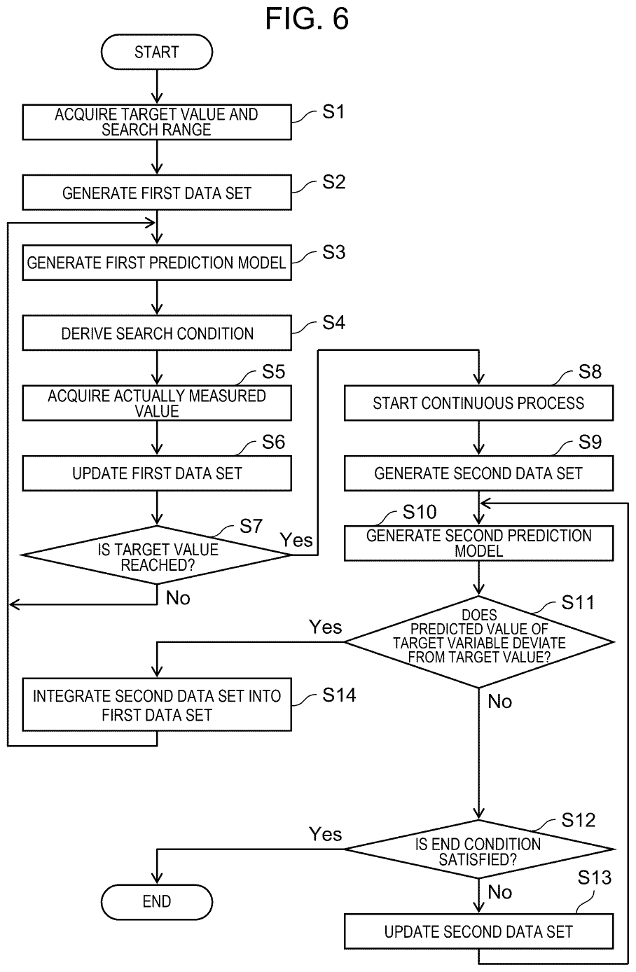

FIG. 6 is a flowchart illustrating an example of processing operation of search device 100 according to the present exemplary embodiment.

First, search condition derivation unit 160 of search device 100 acquires a target value of target variable y and a search range of each of explanatory variable X1 and explanatory variable X2 (step S1). For example, search condition derivation unit 160 may acquire a target value and a search range according to an input operation on an input device such as a keyboard, and when a target value and a search range are stored in storage unit 120, these may be read and acquired from storage unit 120. Alternatively, when search device 100 includes a communication interface, search condition derivation unit 160 may acquire a target value and a search range from the outside of search device 100 via the communication interface.

Next, first data set update unit 111 acquires explanatory variable X1 and explanatory variable X2, which are the first explanatory variables, from apparatus controller 170 by an initial experiment by material processing apparatus 200, and acquires target variable y obtained by processing according to explanatory variable X1 and explanatory variable X2 from material processing apparatus 200. That is, first data set update unit 111 acquires a combination including a value of explanatory variable X1, a value of explanatory variable X2, and a value of target variable y. Then, first data set update unit 111 generates first data set 121 including the combination and stores first data set 121 in storage unit 120 (step S2). Note that the processing in step S2 may be performed before the processing in step S1, or may be performed simultaneously with the processing in step S1.

Note that in an initial experiment, apparatus controller 170 may randomly select a value of explanatory variable X1 and a value of explanatory variable X2 from the search range acquired in step S1, and set these values in material processing apparatus 200. Alternatively, apparatus controller 170 may select a value of explanatory variable X1 and a value of explanatory variable X2 by using a statistical method such as design of experiments. Further, in step S2, first data set update unit 111 may acquire two or more of the above-described combinations and generate first data set 121 including these combinations. The number of the combinations is not particularly limited, and may be one or two. However, as the number of the combinations is larger, prediction accuracy by first prediction model 123 generated from first data set 121 is improved more.

Next, first prediction model generation unit 130 generates first prediction model 123 by machine learning using first data set 121 generated in step S2 (step S3). Then, by using first prediction model 123 generated in step S3, search condition derivation unit 160 derives, as search conditions, a value of explanatory variable X1 and a value of explanatory variable X2 for obtaining a target value of target variable y from the search range acquired in step S1 (step S4). For example, the target value is a value equal to or more than a threshold value.

Next, apparatus controller 170 sets the value of the first explanatory variable X1 and the value of the second explanatory variable X2, which are the search conditions derived in step S4, in material processing apparatus 200, and causes material processing apparatus 200 to perform processing according to the search condition, that is, mixing of the first liquid and the second liquid. As a result, first data set update unit 111 acquires the value of explanatory variable X1 and the value of explanatory variable X2 from apparatus controller 170, and acquires a value of target variable y obtained by mixing according to the value of explanatory variable X1 and the value of explanatory variable X2 from material processing apparatus 200. That is, first data set update unit 111 acquires a combination including the value of explanatory variable X1, the value of explanatory variable X2, and the value of target variable y as an actually measured value (step S5). Then, first data set update unit 111 updates first data set 121 stored in storage unit 120 (step S6). That is, first data set update unit 111 adds a combination including the value of explanatory variable X1, the value of explanatory variable X2, and the value of target variable y acquired in step S5 to first data set 121. At this time, first data set update unit 111 determines whether or not the value of target variable y is more than or equal to a threshold value, and adds the determination result to first data set 121.

Next, search condition derivation unit 160 determines whether or not the value of target variable y most recently added to first data set 121 reaches the target value acquired in step S1 (step S7). For example, when a value of target variable y is more than or equal to “threshold value+15”, search condition derivation unit 160 determines that the value of target variable y reaches the target value. Here, when it is determined that the value of target variable y does not reach the target value (No in step S7), search device 100 repeatedly executes the processing from step S3. That is, first prediction model generation unit 130 generates or updates first prediction model 123 using first data set 121 updated in step S6.

On the other hand, when it is determined in step S7 that the value of target variable y reaches the target value (Yes in step S7), apparatus controller 170 causes material processing apparatus 200 to start a continuous process (step S8). That is, apparatus controller 170 causes material processing apparatus 200 to start a continuous process according to the search condition included in the combination acquired in step S5 most recently, that is, the value of explanatory variable X1 and the value of explanatory variable X2.

When the continuous process starts, second data set update unit 112 acquires explanatory variable A1 and explanatory variable A2, which are the second explanatory variables, and target variable y from material processing apparatus 200. That is, second data set update unit 112 acquires a combination including a value of explanatory variable A1, a value of explanatory variable A2, and a value of target variable y. At this time, second data set update unit 112 may acquire a plurality of combinations. Then, second data set update unit 112 generates second data set 122 including the combination and stores second data set 122 in storage unit 120 (step S9).

Next, second prediction model generation unit 140 generates or updates second prediction model 124 by using second data set 122 generated in step S9 (step S10). After the above, prediction unit 150 predicts a value of each of explanatory variable A1 and explanatory variable A2 and a value of a target variable at a time point later than a current time point. Then, prediction unit 150 determines whether or not a predicted value that is a predicted value of a target variable deviates from a target value (step S11). In a case where the target value is a value more than or equal to a threshold value, prediction unit 150 determines that the predicted value deviates from the target value if the predicted value is less than the threshold value. Here, when it is determined that the predicted value does not deviate from the target value (No in step S11), apparatus controller 170 determines whether or not an end condition is satisfied (step S12). For example, in a case where a predetermined amount or more of product (for example, mixed liquid) is collected by collection unit 260 of material processing apparatus 200, apparatus controller 170 determines that the end condition is satisfied. Then, when determining that the end condition is satisfied (Yes in step S12), apparatus controller 170 ends the continuous process by material processing apparatus 200 and also ends the search for a search condition. On the other hand, when determining that the end condition is not satisfied (No in step S12), apparatus controller 170 continues the continuous process by material processing apparatus 200 and causes second data set update unit 112 to update second data set 122 (step S13). In this case, second data set update unit 112 acquires a combination including a new value of explanatory variable A1, a new value of explanatory variable A2, and a new value of target variable y, and adds the combination to second data set 122 so as to update second data set 122.

On the other hand, when it is determined in step S11 that the predicted value deviates from the target value (Yes in step S11), first data set update unit 111 integrates second data set 122 stored in storage unit 120 into first data set 121 (step S14). At this time, apparatus controller 170 ends the continuous process by material processing apparatus 200. Therefore, the continuous process stage ends and the processing stage of processing system 1000 transitions from the continuous process stage to the search stage. By the integration in step S14, explanatory variable A1 and explanatory variable A2, which are the second explanatory variables, are added to first data set 121, and first data set 121 is updated to an integrated data set. Then, first prediction model generation unit 130 generates or updates first prediction model 123 by using the integrated data set, that is, first data set 121 to which the second explanatory variable is added. That is, derivation of a new search condition is started.

As described above, in the present exemplary embodiment, when a search condition is derived as an optimal solution, and processing on a raw material according to the search condition is continuously performed, that is, at the continuous process stage, it is predicted whether or not a characteristic value of a raw material deviates from a target value at a time point later than a current time point. Therefore, in a case where there is a temporal change in a raw material, it is predicted that a characteristic value deviates from a target value. In such a case, the first prediction model is updated by using the first data set to which the second explanatory variable indicating a state of a raw material is added. As a result, a search using the updated first prediction model is performed again, and a search in consideration of the second explanatory variable, that is, a search in consideration of a temporal change of a raw material can be performed. Therefore, processing on a raw material according to a new search condition derived by the search can be performed as a continuous process, and the possibility of maintaining a characteristic value at a target value can be increased even at a time point later than the above-described current time point. By the above, accuracy of searching for an optimal solution can be improved even in a case where a raw material having a large temporal change is used for producing a product, and a large amount of product having a target characteristic value can be produced continuously.

Further, in the continuous process stage according to the present exemplary embodiment, second data set 122 is generated or updated, and second prediction model 124 generated from second data set 122 is used so as to predict whether or not a characteristic value deviates from a target value. By the above, it is possible to predict with high accuracy whether or not a characteristic value deviates from a target value at a time point later than a current time point.

Further, in the present exemplary embodiment, by integrating second data set 122 into first data set 121, first data set 121 is updated to a data set indicating the first explanatory variable and the second explanatory variable and a target variable in association with each other. By the above, the first explanatory variable and the second explanatory variable and the target variable can be appropriately associated with each other, and the second explanatory variable can be effectively added to first data set 121.

Further, in the present exemplary embodiment, in a case where prediction unit 150 predicts that a characteristic value deviates from a target value when a state of a raw material indicated by the second explanatory variable is a predetermined state, search condition derivation unit 160 derives, as a new search condition, a value of the first explanatory variable for obtaining a target value of target variable y when a state of a raw material is the predetermined state by performing a search using updated first prediction model 123. For example, the predetermined state is indicated by the value “A1k” of explanatory variable A1 and the value “A2k” of explanatory variable A2 as illustrated in part (b) of FIG. 4. When a state of a raw material is such a state, it is predicted that a characteristic value deviates from a target value. Then, as illustrated in part (b) of FIG. 5, values of the first explanatory variables for obtaining a target value of target variable y when a state of a raw material is the predetermined state, that is, the value “X1s” of explanatory variable X1 and the value “X2s” of explanatory variable X2 are derived as new search conditions. By the above, even if the raw material is brought into the predetermined state by a temporal change, it is possible to produce a product having a target characteristic value by causing material processing apparatus 200 to execute processing according to the new search condition.

### Second Exemplary Embodiment

Material processing apparatus 200 according to the present exemplary embodiment has a configuration for adjusting a state of a raw material. Then, search device 100 sets the third explanatory variable for adjusting the state of the raw material in material processing apparatus 200 together with the first explanatory variable. Furthermore, search device 100 adds the third explanatory variable to first data set 121 together with the second explanatory variable. By the above, even in a case where a raw material having a large temporal change is used, a large amount of product having a target characteristic value can be easily produced.

Note that, components according to the present exemplary embodiment identical to components of the first exemplary embodiment are denoted by reference marks identical to those used in the first exemplary embodiment, and detailed descriptions of the components are omitted. Further, in the present exemplary embodiment, a configuration, a processing operation, and the like different from those of the first exemplary embodiment will be mainly described in detail below.

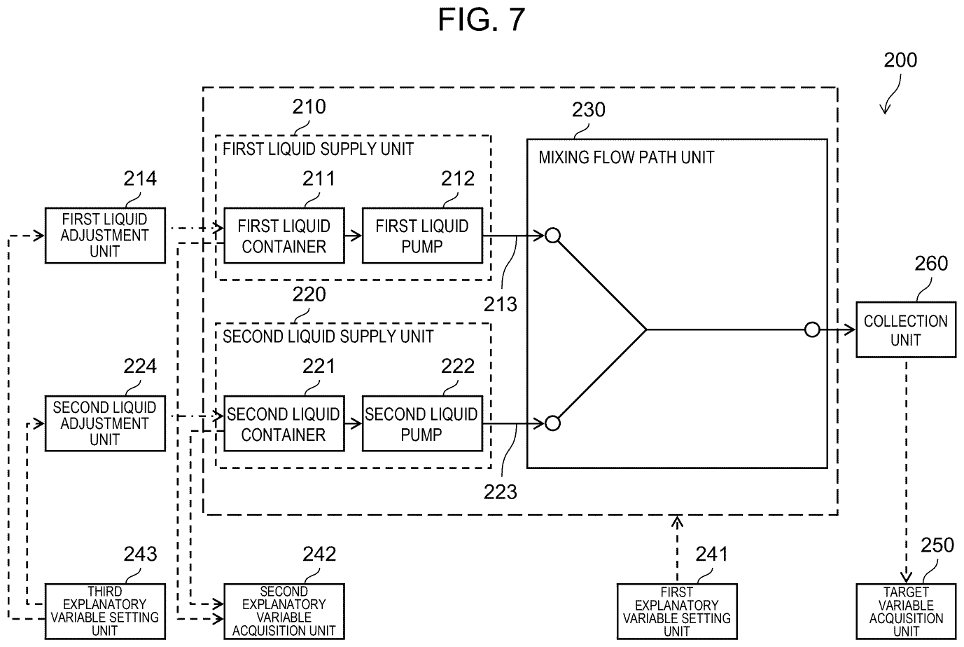

FIG. 7 is a block diagram illustrating an example of a configuration of material processing apparatus 200 according to the present exemplary embodiment.

Material processing apparatus 200 according to the present exemplary embodiment has the same configuration as that of the first exemplary embodiment, and further includes first liquid adjustment unit 214, second liquid adjustment unit 224, and third explanatory variable setting unit 243.

Third explanatory variable setting unit 243 sets a value of the third explanatory variable derived by search device 100 in first liquid adjustment unit 214 and second liquid adjustment unit 224.

First liquid adjustment unit 214 adjusts a state of the first liquid stored in first liquid container 211. For example, first liquid adjustment unit 214 adjusts a state of the first liquid by adding, to the first liquid, an adjustment material such as water, an acid, or a base by an amount corresponding to a value of the third explanatory variable set by third explanatory variable setting unit 243. That is, the second explanatory variable of the first liquid is adjusted by the third explanatory variable.

Second liquid adjustment unit 224 adjusts a state of the second liquid stored in second liquid container 221. For example, similarly to first liquid adjustment unit 214, second liquid adjustment unit 224 adjusts a state of the second liquid by adding, to the second liquid, an adjustment material such as water, an acid, or a base by an amount corresponding to a value of the third explanatory variable set by third explanatory variable setting unit 243. That is, the second explanatory variable of the second liquid is adjusted by the third explanatory variable.

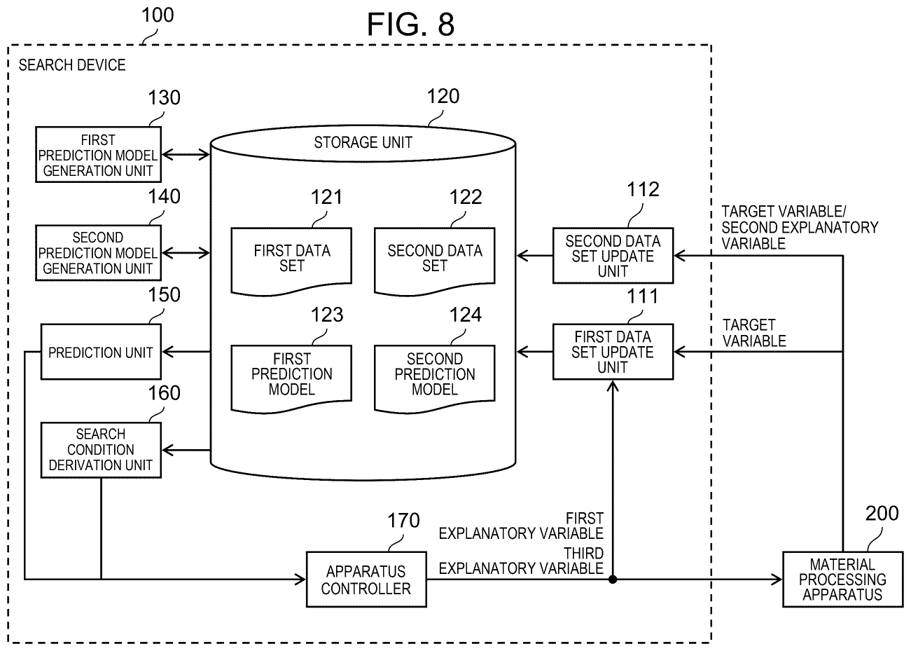

FIG. 8 is a block diagram illustrating an example of a configuration of search device 100 according to the present exemplary embodiment.

Although search device 100 according to the present exemplary embodiment has the same configuration as that of the first exemplary embodiment, first data set update unit 111, first prediction model generation unit 130, search condition derivation unit 160, and apparatus controller 170 according to the present exemplary embodiment further perform operation additional to the first exemplary embodiment.

Specifically, in the present exemplary embodiment, when a predicted value of target variable y deviates from a target value, first data set update unit 111 adds the second explanatory variable and the third explanatory variable to first data set 121, so as to update first data set 121 to an integrated data set. Then, first prediction model generation unit 130 uses the integrated data set to generate first prediction model 123 indicating a relationship between the first explanatory variable, the second explanatory variable, and the third explanatory variable and the target variable. Search condition derivation unit 160 performs a search using first prediction model 123 to derive, as search conditions, a value of the first explanatory variable and a value of the third explanatory variable for obtaining a target value of a target variable. Search condition derivation unit 160 outputs a value of the first explanatory variable and a value of the third explanatory variable, which are derived search conditions, to apparatus controller 170. When acquiring a value of the first explanatory variable and a value of the third explanatory variable as search conditions from search condition derivation unit 160, apparatus controller 170 outputs these values to material processing apparatus 200 and causes material processing apparatus 200 to perform mixing according to these values. Note that a value of the first explanatory variable and a value of the third explanatory variable are also output from apparatus controller 170 to first data set update unit 111.

First explanatory variable setting unit 241 of material processing apparatus 200 acquires a value of the first explanatory variable from apparatus controller 170 and sets the value in, for example, mixing flow path unit 230. Furthermore, third explanatory variable setting unit 243 of material processing apparatus 200 acquires a value of the third explanatory variable from apparatus controller 170 and sets the value in first liquid adjustment unit 214 and second liquid adjustment unit 224. Then, target variable acquisition unit 250 of material processing apparatus 200 outputs a new value of a target variable obtained by processing according to a value of the first explanatory variable and a value of the third explanatory variable to first data set update unit 111.

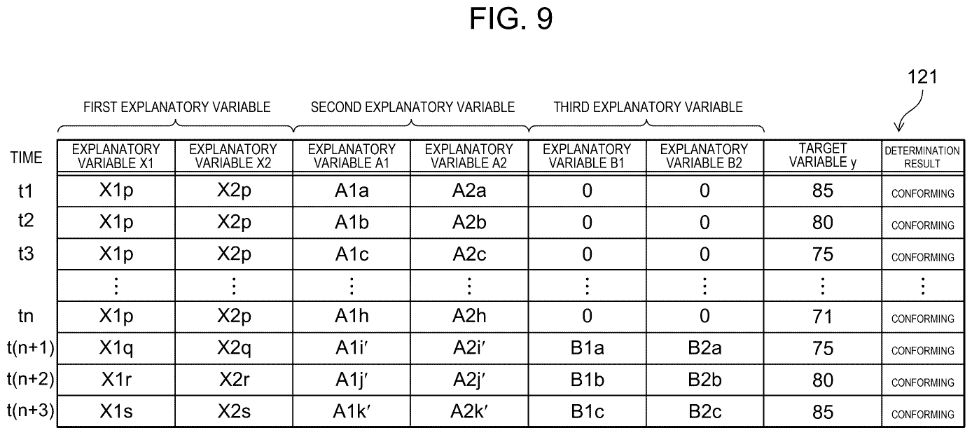

FIG. 9 is a diagram illustrating an example of first data set 121 updated by addition of the second explanatory variable and the third explanatory variable. Note that, also in the present exemplary embodiment, similarly to the example of the first exemplary embodiment, first data set 121 illustrated in part (a) of FIG. 4 is generated at the search stage performed first, and second data set 122 illustrated in part (b) of FIG. 4 is generated at the continuous process stage performed next.

For example, as illustrated in FIG. 9, first data set 121 updated by addition of the second explanatory variable and the third explanatory variable indicates explanatory variable X1 and explanatory variable X2 which are the first explanatory variables, explanatory variable A1 and explanatory variable A2 which are the second explanatory variables, explanatory variable B1 and explanatory variable B2 which are the third explanatory variables, and target variable y in association with each other. First data set update unit 111 integrates second data set 122 into first data set 121 and further adds the third explanatory variable, so as to update first data set 121 to a data set indicating the first explanatory variable, the second explanatory variable, and the third explanatory variable and the target variable in association with each other. First data set 121 updated as described above is also referred to as an integrated data set.

In a specific example, the integrated data set indicates a combination at each of times t1 to tn at the continuous process stage and a combination at each of times t(n+1) to t(n+3) at the search stage after the continuous process stage. The combination includes a value of the first explanatory variable, a value of the second explanatory variable, a value of the third explanatory variable, a value of a target variable, and a determination result for the value of the target variable.

When instructed by apparatus controller 170 to update first data set 121 using the second explanatory variable and the third explanatory variable, first data set update unit 111 first adds a combination of each of times t1 to tn to first data set 121. That is, first data set update unit 111 integrates second data set 122 into first data set 121, and further adds an initial value (for example, 0) of the third explanatory variable at each of the times t1 to tn to first data set 121. By the above, the second explanatory variable and the third explanatory variable are added to first data set 121. As a result, first data set 121 is updated to an integrated data set.

First prediction model generation unit 130 generates first prediction model 123 by using the integrated data set that is updated first data set 121. Furthermore, search condition derivation unit 160 derives, as search conditions, the value “X1q” of explanatory variable X1 and the value “X2q” of explanatory variable X2 and a value “B1a” of explanatory variable B1 and a value “B2a” of explanatory variable B2 at time t(n+1) by performing a search using first prediction model 123. First data set update unit 111 acquires, from material processing apparatus 200, a value “75” of target variable y obtained by processing on a raw material according to the search condition, and a value “A1i′” of explanatory variable A1 and a value “A2i′” of explanatory variable A2 indicating a state of a raw material at that time. Then, first data set update unit 111 determines that the value “75” of target variable y is more than or equal to a threshold value. After the above, first data set update unit 111 adds a combination at the time t(n+1) to first data set 121. The combination includes the value “X1q” of explanatory variable X1 and the value “X2q” of explanatory variable X2, the value “A1i′” of explanatory variable A1 and the value “A2i” of explanatory variable A2, the value “B1a” of explanatory variable B1 and the value “B2a” of explanatory variable B2, the value “75” of target variable y, and a determination result “conforming” for the value “75” of target variable y.

Addition of such a combination to first data set 121 is repeatedly executed until a value more than or equal to “threshold value+15” is obtained as a value of target variable y. In the present exemplary embodiment, the threshold value is, for example, 70. Note that the value added to the threshold value is not limited to 15, and may be another numerical value as long as the value is 0 or more. Here, as illustrated in part (b) of FIG. 4, at time t(n+3), a state of a raw material is changed to a state expressed by a value “A1k” of explanatory variable A1 and a value “A2k” of explanatory variable A2, and as a result, a value of target variable y is predicted to be less than the threshold value. However, in the present exemplary embodiment, at the time t(n+3), the possibility that a state of a raw material changes to a state expressed by the value “A1k” of explanatory variable A1 and the value “A2k” of explanatory variable A2 is reduced. Furthermore, search condition derivation unit 160 can further increase the possibility of deriving a search condition by which a value of target variable y that is more than or equal to a threshold value can be obtained.

When first data set update unit 111 adds the value “85” of target variable y that is “threshold value+15” or more to first data set 121, search condition derivation unit 160 notifies apparatus controller 170 that the search for a search condition is to be stopped. In response to the notification, apparatus controller 170 causes material processing apparatus 200 to execute a continuous process according to a search condition associated with the value “85” of target variable y, that is, a continuous process according to the value “X1s” of explanatory variable X1 and the value “X2s” of explanatory variable X2. By the above, accuracy of searching can be improved, and a large amount of product having a characteristic value to be a target value can be continuously produced.

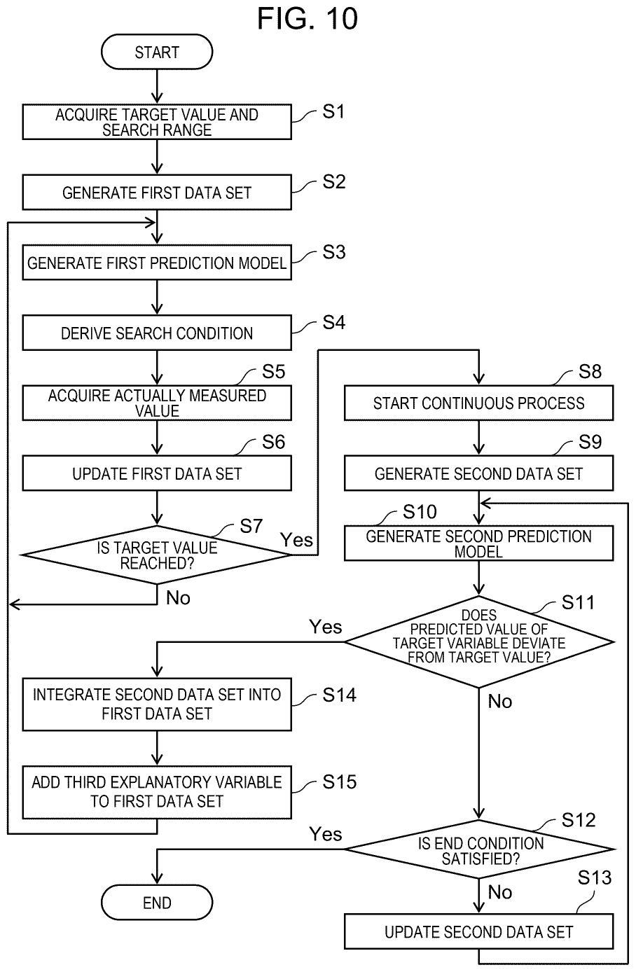

FIG. 10 is a flowchart illustrating an example of processing operation of search device 100 according to the present exemplary embodiment.

Search device 100 according to the present exemplary embodiment executes each step included in the flowchart of FIG. 6 and further executes processing of step S15.

In step S15, first data set update unit 111 further adds the third explanatory variable to first data set 121 integrated in step S14. By this step S15, explanatory variable B1 and explanatory variable B2, which are the third explanatory variables, are added to first data set 121, and first data set 121 is updated to an integrated data set. Then, first prediction model generation unit 130 generates or updates first prediction model 123 by using the integrated data set, that is, first data set 121 to which the third explanatory variable is added. That is, derivation of a new search condition is started.

As described above, in the present exemplary embodiment, when adding the second explanatory variable to first data set 121, first data set update unit 111 updates the first data set by adding the third explanatory variable for adjusting a state of a raw material to first data set 121 together with the second explanatory variable. Then, first prediction model generation unit 130 updates first prediction model 123 by using first data set 121 updated by addition of the second explanatory variable and the third explanatory variable.

By the above, by performing a search using first prediction model 123, it is possible to perform a search in consideration of a state of a raw material that changes over time and adjustment to the state. As a result, it is possible to derive an optimal solution of a search condition for producing a product having a characteristic value as a target value with high accuracy, the search condition including a value of the first explanatory variable and a value of the third explanatory variable.

### Other Modification Examples

While search device 100 according to an aspect of the present disclosure is described above based on the exemplary embodiments, the present disclosure is not limited to the exemplary embodiments. Various modifications made on the above exemplary embodiments by those skilled in the art may be included in the present disclosure, as long as such modifications do not depart from the spirit of the present disclosure.

For example, the number of each of the first explanatory variable, the second explanatory variable, and the third explanatory variable in the first or second exemplary embodiment is two, but the number is not limited to two, and may be one or three or more. Further, although the number of target variables in the first and second exemplary embodiments is one, the number is not limited to one, and may be two or more.

Further, in the first exemplary embodiment, second data set 122 including explanatory variable A1 and explanatory variable A2 as the second explanatory variables is generated in step S9 of FIG. 6; however, in a case where the processing of step S9 is executed again, second data set 122 including the second explanatory variable different from the explanatory variables A1 and A2 may be generated. Even in a case where the processing of step S9 in FIG. 10 in the second exemplary embodiment is executed again, second data set 122 including the second explanatory variable different from the explanatory variables A1 and A2 may be generated. In the second exemplary embodiment, first data set 121 including explanatory variable B1 and explanatory variable B2 as the third explanatory variables is generated in step S15 of FIG. 10; however, in a case where the processing of step S15 is executed again, first data set 121 including the third explanatory variable different from the explanatory variables B1 and B2 may be generated.

Further, in the first and second exemplary embodiments, a target value is more than or equal to a threshold value, but may be a value less than or equal to a threshold value. In this case, when a value of target variable y is less than or equal to “threshold value−15”, search condition derivation unit 160 determines that the value of target variable y reaches the target value.

Further, first prediction model 123 and second prediction model 124 in the first and second exemplary embodiments may be any model as long as the model indicates a relationship, that is, a correlation, between an explanatory variable and a target variable.

Further, the third explanatory variable according to the above exemplary embodiment may be any variable as long as the variable is a variable other than the first explanatory variable and the second explanatory variable.

Note that in each of the exemplary embodiments described above, each component may be implemented by dedicated hardware or by executing a software program suitable for each component. Each component may be implemented by a program execution unit such as a CPU or a processor reading and executing a software program recorded in a recording medium such as a hard disk or a semiconductor memory. Here, software that implements search device 100 and the like of the above-described exemplary embodiments is a program that causes a computer to execute each step of the flowchart illustrated in FIG. 6 or 10, for example.

Note that the following cases are also included in the present disclosure.

(1) The at least one device is specifically a computer system including a microprocessor, a read only memory (ROM), a random access memory (RAM), a hard disk unit, a display, a keyboard, a mouse, and the like. The RAM or the hard disk unit stores a computer program. The microprocessor operates in accordance with the computer program, so that the at least one device achieves its functions. Here, the computer program is configured by combining a plurality of instruction codes indicating commands to a computer in order to achieve a predetermined function.

(2) A part or all of the components constituting the at least one device may include one system large scale integration (LSI). The system LSI is a super multifunctional LSI manufactured by integrating a plurality of component portions on one chip, and is specifically a computer system including a microprocessor, a ROM, a RAM, and the like. The RAM stores a computer program. By a microprocessor operating in accordance with the computer program, the system LSI achieves its functions.

(3) A part or all of components constituting the at least one device may be constituted by an IC card detachable from the device or a single module. The IC card or the module is a computer system including a microprocessor, a ROM, a RAM, and the like. The IC card or the module may include the above-described super multifunctional LSI. The microprocessor operates in accordance with a computer program, so that the IC card or the module achieves its function. The IC card or the module may have tamper resistance.

(4) The present disclosure may be the methods described above. Further, the present disclosure may be a computer program causing a computer to implement these methods, or may be a digital signal including a computer program.

Further, the present disclosure may be a computer program or a digital signal recorded in a computer-readable recording medium such as a flexible disk, a hard disk, a compact disc (CD)-ROM, a DVD, a DVD-ROM, a DVD-RAM, a Blu-ray (registered trademark) disc (BD), or a semiconductor memory. Further, the present disclosure may be a digital signal recorded in these recording media.

Further, the present disclosure may be a computer program or a digital signal transmitted via a telecommunications line, a wireless or wired communication line, a network represented by the Internet, data broadcasting, or the like.

Further, the present disclosure may be carried out by another independent computer system by recording, on a recording medium, and transferring a program or a digital signal, or by transferring a program or a digital signal via a network or the like.

### INDUSTRIAL APPLICABILITY

The search device of the present disclosure can be applied to, for example, a device and a system that search for a processing condition for generating a product having a desired characteristic value as a search condition.

### REFERENCE MARKS IN THE DRAWINGS

100: search device
111: first data set update unit
112: second data set update unit
120: storage unit
121: first data set
122: second data set
123: first prediction model
124: second prediction model
130: first prediction model generation unit
140: second prediction model generation unit
150: prediction unit
160: search condition derivation unit
170: apparatus controller
200: material processing apparatus
210: first liquid supply unit
211: first liquid container
212: first liquid pump
213: first liquid flow path
214: first liquid adjustment unit
220: second liquid supply unit
221: second liquid container
222: second liquid pump
223: second liquid flow path
224: second liquid adjustment unit
230: mixing flow path unit
241: first explanatory variable setting unit
242: second explanatory variable acquisition unit
243: third explanatory variable setting unit
250: target variable acquisition unit
260: collection unit
1000: processing system

1. A search device comprising:
a first data set update unit that generates or updates a first data set indicating a target variable and a first explanatory variable in association with each other, the target variable indicating a characteristic value of a product obtained by processing by a material processing apparatus, the processing being performed on a raw material according to the first explanatory variable;
a first prediction model generation unit that generates a first prediction model by using the first data set, the first prediction model indicating a relationship between the first explanatory variable and the target variable;
a search condition derivation unit that derives, as a search condition, a value of the first explanatory variable for obtaining a target value of the target variable, the deriving being performed by a search using the first prediction model; and
a prediction unit that predicts whether or not the characteristic value indicated by the target variable deviates from the target value at a time point later than a current time point when the processing on the raw material according to the search condition derived by the search condition derivation unit is continuously performed, wherein
the first data set update unit updates the first data set in a case where the prediction unit predicts that the characteristic value deviates from the target value by adding a second explanatory variable to the first data set, the second explanatory variable indicating a state of the raw material, and
the first prediction model generation unit updates the first prediction model by using the first data set updated by addition of the second explanatory variable.

2. The search device according to claim 1, further comprising:
a second data set update unit that acquires the second explanatory variable and the target variable and generates or updates a second data set indicating the acquired second explanatory variable and the acquired target variable in association with each other when processing on the raw material according to the search condition derived by the search condition derivation unit is continuously performed; and
a second prediction model generation unit that generates a second prediction model by using the second data set, the second prediction model indicating a temporal relationship between the second explanatory variable and the target variable, wherein the prediction unit predicts whether or not the characteristic value deviates from the target value by using the second prediction model.

3. The search device according to claim 2, wherein
the first data set update unit, in the adding the second explanatory variable to the first data set, updates the first data set to a data set indicating the first explanatory variable, the second explanatory variable, and the target variable in association with each other by integrating the second data set into the first data set.

4. The search device according to claim 2, wherein
in a case where the prediction unit predicts that the characteristic value deviates from the target value when the state of the raw material indicated by the second explanatory variable is a predetermined state,
the search condition derivation unit derives, as a new search condition, a value of the first explanatory variable for obtaining the target value of the target variable when the state of the raw material is the predetermined state, the deriving being performed by a search using the updated first prediction model.

5. The search device according to claim 2, wherein
the first data set update unit updates the first data set by adding a third explanatory variable for adjusting a state of the raw material to the first data set together with the second explanatory variable when adding the second explanatory variable to the first data set, and
the first prediction model generation unit updates the first prediction model by using the first data set updated by addition of the second explanatory variable and the third explanatory variable.

6. A search method using a computer, the search method comprising:
generating or updating a first data set indicating a target variable and a first explanatory variable in association with each other, the target variable indicating a characteristic value of a product obtained by processing by a material processing apparatus, the processing being performed on a raw material according to the first explanatory variable;
generating a first prediction model by using the first data set, the first prediction model indicating a relationship between the first explanatory variable and the target variable;
deriving, as a search condition, a value of the first explanatory variable for obtaining a target value of the target variable, the deriving being performed by a search using the first prediction model;
predicting whether or not the characteristic value indicated by the target variable deviates from the target value at a time point later than a current time point when the processing on the raw material according to the derived search condition is continuously performed;
updating the first data set in a case where the characteristic value deviates from the target value by adding a second explanatory variable to the first data set, the second explanatory variable indicating a state of the raw material; and
updating the first prediction model by using the first data set updated by addition of the second explanatory variable.

7. A program that causes a computer to execute:
generating or updating a first data set indicating a target variable and a first explanatory variable in association with each other, the target variable indicating a characteristic value of a product obtained by processing by a material processing apparatus, the processing being performed on a raw material according to the first explanatory variable;
generating a first prediction model by using the first data set, the first prediction model indicating a relationship between the first explanatory variable and the target variable;
deriving, as a search condition, a value of the first explanatory variable for obtaining a target value of the target variable, the deriving being performed by a search using the first prediction model;
predicting whether or not the characteristic value indicated by the target variable deviates from the target value at a time point later than a current time point when the processing on the raw material according to the derived search condition is continuously performed;
updating the first data set in a case where the characteristic value deviates from the target value by adding a second explanatory variable to the first data set, the second explanatory variable indicating a state of the raw material; and
updating the first prediction model by using the first data set updated by addition of the second explanatory variable.
